(19) United States
(12) Patent Application Publication
(10) Pub. No.: US 2018/0296986 A1
(43) Pub. Date: Oct. 18, 2018

(54) PRESSURE-RESISTANT POROUS MACROMOLECULAR PMMA FILTER MEMBRANE MATERIAL

(71) Applicant: SHENZHEN MUNICIPAL QIDE ENVIRONMENTAL SCI-TECH CO., LTD., Shenzhen (CN)

(72) Inventors: Cai'er ZHENG, SHENZHEN (CN); Yuezhong CHEN, SHENZHEN (CN)

(73) Assignee: SHENZHEN MUNICIPAL QIDE ENVIRONMENTAL SCI-TECH CO., LTD.

(21) Appl. No.: 16/015,155

(22) Filed: Jun. 21, 2018

Related U.S. Application Data
(63) Continuation of application No. PCT/CN2016/109070, filed on Dec. 8, 2016.

(30) Foreign Application Priority Data
Feb. 22, 2016 (CN) 201610096503.2

(51) Int. Cl. B01D 69/12; B01D 71/82; B01D 67/00; B01D 71/48

(52) U.S. Cl. CPC B01D 69/125; B01D 71/82; B01D 71/40; B01D 71/48; B01D 67/0011

(57) ABSTRACT

A pressure-resistant porous macromolecular PMMA filter membrane material comprises the following ingredients in parts by weight: 60-95 parts of PMMA, 60-90 parts of MMA, 0.5-25 parts of surfactant and 5-25 parts of water. The filter membrane material is simple in preparation process, and the prepared pressure-resistant porous macromolecular filter membrane material contains no bubble, has a uniform pore size, an adjustable micro pore size of 0.01-12 μm, a special-purpose pore size of 13-80 μm, a porosity of 20-38% and a water permeability rate greater than 20%. The filter membrane material has the characteristics of reusability, light weight, high mechanical strength, excellent impact resistance, high pressure resistance, low molding shrinkage, good water permeability, adjustable pore size and the like.

### CROSS-REFERENCE TO RELATED APPLICATIONS

This application is a continuation of International Patent Application No. PCT/CN2016/109070 with a filing date of Dec. 8, 2016, designating the United States, now pending, and further claims priority to Chinese Patent Application No. 201610096503.2 with a filing date of Feb. 22, 2016. The content of the aforementioned applications, including any intervening amendments thereto, are incorporated herein by reference.

### TECHNICAL FIELD

The present disclosure relates to the technical field of macromolecular polymerization, and particularly relates to a pressure-resistant porous macromolecular filter membrane material.

### BACKGROUND OF THE PRESENT INVENTION

At present, filter materials commonly used in domestic and foreign industries are generally made from filter paper, filter cloth, metal nets, ceramics, activated carbon and the like. Defects of the filter materials mainly include non-uniform pore size, low filtering precision, easy dropping of fibers, frequent wearing of parts of the system, frequent mechanical failures, short service life and the like. Although a macromolecular filter material in the prior art solves the problem of non-uniform pore size, the prior art has the defects of complicated preparation process, difficulty in enlarging an industrial production scale, etc.

### SUMMARY OF PRESENT INVENTION

A purpose of the present disclosure is to overcome the above defects and propose a pressure-resistant porous macromolecular polymethyl methacrylate (PMMA) filter membrane material with a uniform product pore size and a simple process flow.

Technical solutions of the present disclosure are as follows: the pressure-resistant porous macromolecular PMMA filter membrane material includes the following raw materials in parts by weight: 60-95 parts of PMMA, 60-90 parts of Methyl methacrylate (MMA), 0.5-25 parts of surfactant and 5-25 parts of water. Preferably, the filter membrane material further includes 0.01-5 parts by weight of initiator. Preferably, the filter membrane material further includes 0.01-8 parts by weight of accelerant.

Further, the accelerant comprises N,N-dimethyl-p-toluidine, N,N-diethylaniline, N,N-dimethylbenzylamine, zinc isoocatanoate, cobalt naphthenate, or a mixture thereof.

Further, the surfactant is a cationic surfactant, an anionic surfactant, a nonionic surfactant or a zwitterionic surfactant.

Further, the cationic surfactant includes a quaternary ammonium salt cationic surfactant (1631); the anionic surfactant includes sodium dodecyl benzene sulfonate; the nonionic surfactant comprises alkylphenol ethoxylates (TX, OP or NP series), fatty glyceride, sorbitan fatty acid ester (Span, mainly including S-20, S-60, S-80, S-85 and the like), polyoxyethylene sorbitan fatty acid ester (Tween), or a mixture thereof; and the zwitterionic surfactant comprises lecithin, an amino acid type surfactant, a betaine type surfactant, or a mixture thereof.

Further, the initiator comprises a photoinitiator, a peroxide, an azo-compound, or a mixture thereof.

Further, the initiator is the photoinitiator 2-hydroxy-2-methyl-1-phenylacetone or 1-hydroxycyclohexylphenylketone; the peroxide comprises benzoyl peroxide, benzoyl peroxide, diisopropyl percarbonate, di-sec-butyl percarbonate, or a mixture thereof, and the azo-compound is 2,2′-azobisisoheptonitrile.

Preferably, the filter membrane material further includes 0.5-8 parts by weight of co-emulsifier.

A micro through hole is formed by adopting “emulsion polymerization” in the method. A basic principle of the method includes the steps: preparing oil-in-water emulsion from a macromolecule prepolymer, monomers, water and a surfactant while stirring, and dispersing the water into the monomer in a droplet form, wherein the droplets are not connected with one another; and carrying out a polymerization reaction on the monomers in the presence of the initiator and the accelerant, and polymerizing the monomers into solids along with the reaction, thereby decreasing the volume. Meanwhile, since the structure of the oil-in-water emulsion is damaged due to temperature rise and other factors, the water or oil is communicated with the holes, thereby forming the micro through hole in the cured macromolecular material.

The pressure-resistant porous macromolecular PMMA filter membrane material in the present disclosure includes the following raw materials in parts by weight: 60-95 parts of PMMA, 60-90 parts of MMA, 0.5-25 parts of surfactant and 5-25 parts of water. The pressure-resistant porous macromolecular PMMA filter membrane material in the present disclosure is simple in preparation process and easy to be molded and processed. The macromolecular PMMA filter membrane material prepared in the present disclosure contains no bubble, has a uniform pore size, an adjustable micro pore size of 0.01-15 μm as required, a special-purpose pore size of 16-80 μm, porosity of 20-38% and a water permeability rate greater than 20%. The pressure-resistant porous macromolecular PMMA filter membrane material in the present disclosure has characteristics of reusability, light weight, high mechanical strength, excellent impact resistance, high pressure resistance, low molding shrinkage, good water permeability, adjustable pore size and the like, can be applied to water treatment fields in drinking water purification, environmental conservation, chemical engineering and the like, and is also a highly preferred filter material for separation and enrichment of materials in fields such as food, pharmaceutical manufacturing and national defense and military.

### DETAILED DESCRIPTION OF PREFERRED EMBODIMENTS

Technical solutions in embodiments of the present disclosure are clearly and completely described below in combination with embodiments of the present disclosure. Apparently, the described embodiments are only part of embodiments in the present disclosure, rather than all of embodiments. Based on embodiments in the present disclosure, all other embodiments obtained by those ordinary skilled in the art on the premise of not making creative work belong to a protection scope of the present disclosure.

### Embodiment 1

A pressure-resistant porous macromolecular PMMA filter membrane material includes the following raw materials in parts by weight: 80 parts of polymethyl methacrylate (PMMA), 30 parts of methyl methacrylate (MMA), 0.5 part of TX-10 and 15 parts of water.

A preparation method includes the following steps:

1) adding 3000 g of MMA and 50 g of TX-10 into a reaction container for uniformly mixing, and adding 1500 mL of water and stirring into a mixture;

2) adding 8000 g of PMMA into the mixture obtained in the step 1) and uniformly stirring;

3) curing and molding the mixture obtained in the step 2) to obtain a semi-finished product; and

4) soaking the cured and molded semi-finished product in hot water for 1 h, thereby obtaining the finished product.

### Embodiment 2

A pressure-resistant porous macromolecular PMMA filter membrane material includes the following raw materials in parts by weight: 95 parts of PMMA, 90 parts of MMA, 15 parts of TX-10, 10 parts of 1631 and 15 parts of water.

A preparation method includes the following steps:

1) adding 9000 g of MMA, 1500 g of TX-10 and 1000 g of 1631 into a reaction container for uniformly mixing, and adding 1500 mL of water and stirring into a mixture;

2) adding 9500 g of PMMA into the mixture obtained in the step 1) and uniformly stirring;

3) curing and molding the mixture obtained in the step 2) to obtain a semi-finished product; and

4) soaking the cured and molded semi-finished product in hot water for 10 h, thereby obtaining the finished product.

### Embodiment 3

A pressure-resistant porous macromolecular PMMA filter membrane material includes the following raw materials in parts by weight: 95 parts of PMMA, 90 parts of MMA, 5 parts of S-85, 0.01 part of diisopropyl percarbonate and 25 parts of deionized water.

A preparation method includes the following steps:

1) adding 9000 g of MMA and 500 g of S-85 in the above raw materials in formula ration into a reaction container and uniformly mixing, and adding 1500 mL of water and stirring into a mixture;

2) adding 9500 g of PMMA into the residual water and then uniformly stirring;

3) adding the mixture in the step 2) into the mixture obtained in the step 1) and uniformly stirring;

4) adding 1 g of diisopropyl percarbonate into the mixture obtained in the step 3) and uniformly stirring;

5) curing and molding the mixture obtained in the step 4) to obtain a semi-finished product; and

6) soaking the cured and molded semi-finished product in hot water for 10 h, thereby obtaining the finished product.

### Embodiment 4

A pressure-resistant porous macromolecular PMMA filter membrane material includes the following raw materials in parts by weight: 60 parts of PMMA, 90 parts of MMA, 5 parts of OP, 5 parts of 1-hydroxycyclohexylphenylketone and 25 parts of deionized water.

A preparation method includes the following steps:

1) adding monomers such as 9000 g of MMA, 500 g of OP and 500 g of 1-hydroxycyclohexylphenylketone into a reaction container and uniformly mixing, and adding 2500 mL of water and stirring into a mixture;

2) adding 6000 g of PMMA into the mixture obtained in the step 1) and uniformly stirring;

3) curing and molding the mixture obtained in the step 2) to obtain a semi-finished product; and

4) soaking the cured and molded semi-finished product in hot water for 3 h, thereby obtaining the finished product.

### Embodiment 5

A pressure-resistant porous macromolecular PMMA filter membrane material includes the following raw materials in parts by weight: 80 parts of PMMA, 30 parts of MMA, 10 parts of TX-10, 3 parts of benzoyl peroxide, 0.5 part of hexadecanol and 15 parts of deionized water.

A preparation method includes the following steps:

1) adding monomers such as MMA, TX-10, benzoyl peroxide and hexadecanol into a reaction container and uniformly mixing, and adding water and stirring into a mixture;

2) adding PMMA into the mixture obtained in the step 1) and uniformly stirring;

3) curing and molding the mixture obtained in the step 2) to obtain a semi-finished product; and

4) soaking the cured and molded semi-finished product in hot water for 5 h, thereby obtaining the finished product.

### Embodiment 6

A pressure-resistant porous macromolecular PMMA filter membrane material includes the following raw materials in parts by weight: 13 parts of MMA, 70 parts of PMMA, 1 part of TX-10, 0.5 part of benzoyl peroxide, 0.5 part of N,N-dimethyl-p-toluidine and 15 parts of water.

A preparation method includes the following steps:

1.1) adding 1300 g of MMA, 100 g of TX-10 and 50 g of N,N-dimethyl-p-toluidine into a reaction container and uniformly mixing, and adding 1500 mL of water and uniformly mixing and stirring;

1.2) adding 7000 g of PMMA with a particle size of 0.1 mm, and stirring for completely dissolving;

1.3) adding 50 g of benzoyl peroxide into a solution, and uniformly mixing and stirring to obtain fluid slurry;

1.4) injecting the fluid slurry into a mold, standing for 1 h, and completely curing and molding to obtain a semi-finished product; and

1.5) demolding the cured and molded semi-finished product and then soaking in hot water for 2 h, thereby obtaining the finished product.

### Embodiment 7

A pressure-resistant porous macromolecular PMMA filter membrane material includes the following raw materials in parts by weight: 15 parts of pre-polymerized MMA slurry, 80 parts of PMMA, 4.89 parts of OP, 0.01 part of 2,2′-azobisisoheptonitrile, 0.01 part of N,N-diethylaniline and 5 parts of water.

A preparation method includes the following steps:

1.1) adding 1500 g of pre-polymerized MMA slurry, 489 g of OP, 1 g of an accelerant (N,N-diethylaniline), 1 g of initiator (2,2′-azobisisoheptonitrile) and 2500 mL of water into a reaction container and uniformly mixing;

1.2) adding 8000 g of PMMA with a particle size of 0.05 mm, and stirring for completely dissolving so as to obtain fluid slurry;

1.3) injecting the fluid slurry into a mold, standing for 2 h, and completely curing and molding to obtain a semi-finished product; and

1.4) demolding the cured and molded semi-finished product and then soaking in hot water for 3 h, thereby obtaining the finished product.

### Embodiment 8

A pressure-resistant porous macromolecular PMMA filter membrane material includes the following raw materials in parts by weight: 48 parts of pre-polymerized MMA slurry, 12 parts of PMMA, 0.5 part of TX10, 5 parts of diisopropyl percarbonate, 8 parts of N,N-dimethylbenzylamine and 25 parts of water.

A preparation method includes the following steps:

1.1) adding 4800 g of pre-polymerized MMA slurry, 50 g of TX10 and 800 g of N,N-dimethylbenzylamine (an accelerant) into a reaction container for uniformly mixing, and adding 2500 mL of water for uniformly mixing;

1.2) adding 1200 g of PMMA with a particle size of 0.08 mm, and stirring or completely dissolving;

1.3) adding 500 g of diisopropyl percarbonate into the solution, uniformly mixing and stirring to obtain fluid slurry, and vacuumizing to remove bubbles in the slurry;

1.4) injecting the fluid slurry into a mold, standing for 5 h, and completely curing and molding to obtain a semi-finished product; and

1.5) demolding the cured and molded semi-finished product and then soaking in hot water for 3 h, thereby obtaining the finished product.

### Embodiment 9

A pressure-resistant porous macromolecular PMMA filter membrane material includes the following raw materials in parts by weight: 12 parts of MMA, 59 parts of PS, 6 parts of S30, 2 parts of 2-hydroxy-2-methyl-1-phenylacetone, 0.05 part of zinc isoocatanoate and 20 parts of water.

A preparation method includes the following steps:

1.1) adding 1200 g of MMA, 600 g of S30, 5 g of zinc isoocatanoate and 2000 mL of water into a reaction container and uniformly mixing;

1.2) adding 5900 g of PS, and stirring for completely dissolving;

1.3) adding 200 g of 2-hydroxy-2-methyl-1-phenylacetone into the solution, uniformly mixing and stirring to obtain fluid slurry, and vacuumizing to remove bubbles in the slurry;

1.4) injecting the fluid slurry into a mold, heating to 50° C., and completely curing and molding to obtain a semi-finished product; and

1.5) demolding the cured and molded semi-finished product and then soaking in hot water for 3 h, thereby obtaining the finished product.

### Embodiment 10

A pressure-resistant porous macromolecular PMMA filter membrane material includes the following raw materials in parts by weight: 38 parts of MMA, 38 parts of PMMA, 0.5 part of TX10, 0.5 part of benzoyl peroxide, 0.3 part of cobalt naphthenate and 14 parts of water.

A preparation method includes the following steps:

1.1) adding 3800 g of MMA, 50 g of TX10, 30 g of cobalt naphthenate and 1400 mL of water into a reaction container and uniformly mixing;

1.2) adding 3800 g of PMMA with a particle size of 0.1 mm, and stirring for completely dissolving;

1.3) adding 50 g of benzoyl peroxide into the solution, and uniformly mixing and stirring to obtain fluid slurry;

1.4) injecting the fluid slurry into a mold, heating to 60° C., and completely curing and molding to obtain a semi-finished product; and

1.5) demolding the cured and molded semi-finished product and soaking in hot water for 2 h, thereby obtaining the finished product.

### Embodiment 11

A pressure-resistant porous macromolecular PMMA filter membrane material includes the following raw materials in parts by weight: 35 parts of MMA, 40 parts of PMMA, 2.5 parts of OP, 2 parts of di-sec-butyl percarbonate, 2 parts of cobalt naphthenate and 13 parts of water.

A preparation method includes the following steps:

1.1) adding 3500 g of MMA, 250 g of OP, 200 g of cobalt naphthenate and 1300 mL of water into a reaction container and uniformly mixing;

1.2) adding 4000 g of PMMA with a particle size of 0.05 mm, and stirring for completely dissolving;

1.3) adding 200 g of di-sec-butyl percarbonate into the solution, and uniformly mixing and stirring to obtain fluid slurry;

1.4) injecting the fluid slurry into a mold, heating to 80° C., and completely curing and molding to obtain a semi-finished product; and

1.5) demolding the cured and molded semi-finished product and soaking in hot water for 3 h, thereby obtaining the finished product.

### Embodiment 12

A pressure-resistant porous macromolecular PMMA filter membrane material includes the following raw materials in parts by weight: 17 parts of MMA, 61 parts of PMMA, 4.6 parts of TX10, 0.03 part of benzoyl peroxide (BPO), 0.4 part of N,N-dimethyl-p-toluidine and 17 parts of water.

A preparation method includes the following steps:

1.1) adding 1700 g of MMA, 460 g of TX10, 40 g of N,N-dimethyl-p-toluidine and 1700 mL of water into a reaction container and uniformly mixing;

1.2) adding 6100 g of PMMA with a particle size of 0.08 mm, and stirring for completely dissolving;

1.3) adding 3 g of benzoyl peroxide into the solution, uniformly mixing and stirring to obtain fluid slurry, and vacuumizing to remove bubbles in the solution;

1.4) injecting the fluid slurry into a mold, heating to 90° C., and completely curing and molding to obtain a semi-finished product; and

1.5) demolding the cured and molded semi-finished product and soaking in hot water for 2 h, thereby obtaining the finished product.

### Embodiment 13

A pressure-resistant porous macromolecular PMMA filter membrane material includes the following raw materials in parts by weight: 17 parts of MMA, 61 parts of PMMA, 4.57 parts of OP, 0.4 part of benzoyl peroxide (BPO), 0.03 part of N,N-diethylaniline and 17 parts of water.

A preparation method includes the following steps:

1.1) adding 1700 g of MMA, 457 g of OP, 40 g of benzoyl peroxide, 3 g of N,N-diethylaniline and 1700 mL of water into a reaction container and uniformly mixing;

1.2) adding 6100 g of PMMA with a particle size of 0.05 mm, and mixing and uniformly stirring so as to obtain fluid slurry;

1.3) injecting the fluid slurry into a mold, standing for 1 h, and completely curing and molding to obtain a semi-finished product; and

1.4) demolding the cured and molded semi-finished product and soaking in hot water for 3 h, thereby obtaining the finished product.

The pressure-resistant porous macromolecular PMMA filter membrane material prepared in the present disclosure has specific gravity of 1.05-1.12, compressive strength of 25-28 MPa, breaking strength of 13-15 MPa, finished product shrinkage less than 0.5%, a water permeability rate greater than 20%, porosity of 20-38%, a micro pore size of 0.01-12 μm, a special-purpose pore size of 13-80 μm, excellent permeability performance and the like. Since a macromolecular material soluble in the MMA is added into the macromolecular filter material in the present disclosure, and less polymerization heat is generated in the polymerization reaction, an implosion phenomenon is avoided, and the prepared macromolecular material contains no bubble and has a uniform pore size.

The pressure-resistant porous macromolecular PMMA filter membrane material prepared in the present disclosure is simple in preparation process, fast in room temperature curing and heated curing and easy to be molded and processed. The pressure-resistant porous macromolecular PMMA filter membrane material in the present disclosure has characteristics of reusability, light weight, high mechanical strength, excellent impact resistance, high pressure resistance, low molding shrinkage, good water permeability, adjustable pore size and the like, can be applied to water treatment fields in drinking water purification, environmental conservation, chemical engineering and the like, and is also preferred for separation and enrichment of material, filter material and water permeable material in fields such as food, pharmaceutical manufacturing and national defense and military.

The above only describes preferred embodiments of the present disclosure, rather than limits the present disclosure. All modifications, equivalent replacements, improvements and the like made in the spirit and principle of the present disclosure should be included in the protection scope of the present disclosure.

We claim:

1. A pressure-resistant porous macromolecular filter membrane material, comprising the following raw materials in parts by weight: 60-95 parts of PMMA, 30-90 parts of MMA, 0.5-25 parts of surfactant and 5-25 parts of water.

2. The pressure-resistant porous macromolecular filter membrane material according to claim 1, wherein the filter membrane material further comprises 0.01-5 parts by weight of an initiator.

3. The pressure-resistant porous macromolecular filter membrane material according to claim 1, wherein the filter membrane material further comprises 0.01-8 parts by weight of an accelerant.

4. The pressure-resistant porous macromolecular filter membrane material according to claim 3, wherein the accelerant comprises N,N-dimethyl-p-toluidine, N,N-diethylaniline, N,N-dimethylbenzylamine, zinc isoocatanoate, cobalt naphthenate, or a mixture thereof.

5. The pressure-resistant porous macromolecular filter membrane material according to claim 1, wherein the surfactant is a cationic surfactant, an anionic surfactant, a nonionic surfactant or a zwitterionic surfactant.

6. The pressure-resistant porous macromolecular filter membrane material according to claim 5, wherein the cationic surfactant comprises a quaternary ammonium salt cationic surfactant; the anionic surfactant comprises sodium dodecyl benzene sulfonate; the nonionic surfactant comprises alkylphenol ethoxylates, fatty glyceride, sorbitan fatty acid ester, or polyoxyethylene sorbitan fatty acid ester; and the zwitterionic surfactant comprises lecithin, an amino acid type surfactant, or a betaine type surfactant.

7. The pressure-resistant porous macromolecular filter membrane material according to claim 1, wherein the initiator comprises a photoinitiator, a peroxide, or an azo-compound.

8. The pressure-resistant porous macromolecular filter membrane material according to claim 7, wherein the photoinitiator is 2-hydroxy-2-methyl-1-phenylacetone or 1-hydroxycyclohexylphenylketone; the peroxide comprises benzoyl peroxide, benzoyl peroxide, diisopropyl percarbonate, di-sec-butyl percarbonate, or a mixture thereof; and the azo-compound is 2,2′-azobisisoheptonitrile.

9. The pressure-resistant porous macromolecular filter membrane material according to claim 1, wherein the filter membrane material further comprises 0.5-8 parts by weight of co-emulsifier.

10. The pressure-resistant porous macromolecular filter membrane material according to claim 9, wherein the co-emulsifier is hexadecane or hexadecanol.
